(19) United States
(12) Patent Application Publication
(10) Pub. No.: US 2014/0311106 A1
(43) Pub. Date: Oct. 23, 2014

(54) DUST CLEANING APPARATUS

(71) Applicant: BENQ CORPORATION, Taipei City (TW)

(72) Inventor: Chi-Cheng Lin, Taoyuan County (TW)

(73) Assignee: BENQ CORPORATION, Taipei City (TW)

(21) Appl. No.: 14/191,441

(22) Filed: Feb. 27, 2014

(30) Foreign Application Priority Data
Apr. 18, 2013 (TW) 102113715

(51) Int. Cl. B01D 46/00

(52) U.S. Cl. CPC B01D 46/0072
USPC 55/304

(57) ABSTRACT

A dust cleaning apparatus comprising a sieve, a beater and a driver is provided. The beater includes a moving part and a beating part. The moving part rotates around a shaft for a circular motion or vibrates relative to a supporting rod for a vibration motion. The beating part is disposed on the moving part and beats the sieve by the movement of the moving part. The driver connects the shaft or the supporting rod to drive the moving part in motion.

This application claims the benefit of Taiwan application Serial No. 102113715, filed Apr. 18, 2013, the subject matter of which is incorporated herein by reference.

### BACKGROUND OF THE INVENTION

1. Field of the Invention

The invention relates in general to a dust cleaning apparatus, and more particularly to a dust cleaning apparatus which cleans the sieve by beating.

2. Description of the Related Art

To achieve a better dust cleaning effect, the dust cleaning normally uses a sieve to trap the dust from the air. After the sieve is used over a period of time, the dust is accumulated to an amount that affects the filtering effect of the sieve. The most commonly used sieve is a detachable sieve, which can be cleaned periodically to maintain cleanness. However, since the detachable sieve must be cleaned manually, additional cleaning cost is required.

Also, the sieve can be cleaned through a relative movement between a brush and the sieve. However, after the brush is used over a period of time, the brush will be deformed due to fraction and needs to be replaced. Although the sieve cleaned with a brush does not need to be replaced, the brush still needs to be cleaned periodically because dust will be accumulated on the brush. If the brush is too dusty or deformed and cannot remove the dust off the sieve, the cleaning effect of the sieve will deteriorate. Moreover, constant pressure contact cannot achieve good dust cleaning effect because some particles will be pressed into the sieve.

### SUMMARY OF THE INVENTION

The invention is directed to a dust cleaning apparatus which cleans the sieve by beating to improve the cleanness of the sieve and does not need to replace the sieve.

According to one embodiment of the present invention, a dust cleaning apparatus comprising a sieve, a beater and a driver is provided. The beater comprises a moving part and a beating part. The moving part rotates around a shaft or vibrates relative to a supporting rod. The beating part is disposed on the moving part and beats the sieve by the movement of the moving part. The driver connects the shaft or the supporting rod to drive the moving part in motion.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIGS. 1 and 2 are a solid diagram of a dust cleaning apparatus and a sketch diagram of beating positions of the dust cleaning apparatus according to an embodiment of the invention, respectively.

FIGS. 3A-3D are side views of four kinds of beaters.

FIGS. 4A-4D are top views of each kind of beater.

FIGS. 5A-5D are schematic diagrams of four kinds of drivers.

FIGS. 6A-6D are schematic diagrams of a beating part storing and releasing kinetic energy by using a torque storage/release member.

FIG. 7 is a schematic diagram of a sieve strengthened by using reinforcing ribs.

### DETAILED DESCRIPTION OF THE INVENTION

The dust cleaning apparatus in the present embodiment cleans the dust by beating the sieve with a beater and produces a better dust cleaning effect than a brush or a scraper. Furthermore, unlike the brush which needs to be replaced when the brush is deformed due to fraction, the dust cleaning apparatus in the present embodiment does not need to replace any brushes and saves replacement cost. The ways of beating the sieve with a beater and the magnitude of the beating force can be controlled by a driver. For instance, the beater can beat the sieve by way of rotation or vibration. The driver can indirectly drive the beater by using a gear, a belt or a crank wheel or can directly drive the beater by using a direct drive motor. Moreover, the beating force of the beater can be adjusted by adjusting the kinetic energy of the rotation of the beater or adjusting the vibration amplitude of the beater. The larger the beating force or the faster the acceleration at the instant of beating, the better the sieve cleaning effect.

A number of embodiments are disclosed below for elaborating the invention. However, the embodiments of the invention are for detailed descriptions only, not for limiting the scope of protection of the invention.

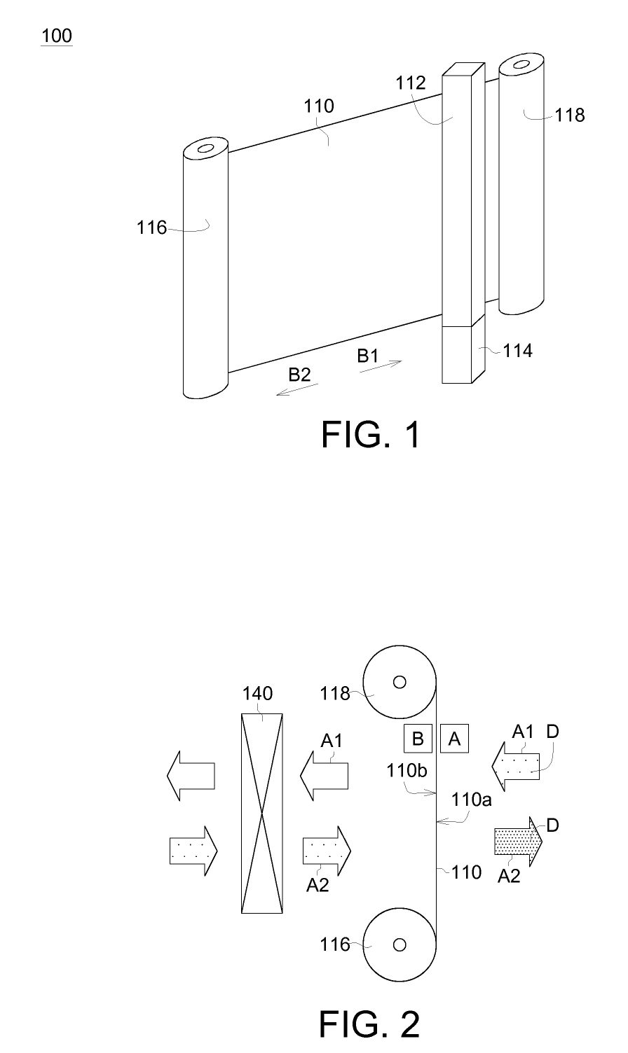

Referring to FIGS. 1 and 2, a solid diagram of a dust cleaning apparatus 100 and a sketch diagram of beating positions of the dust cleaning apparatus 100 according to an embodiment of the invention are respectively shown. The dust cleaning apparatus 100 comprises a sieve 110, a beater 112 and a driver 114. The beater 112 beats the sieve 110 to clean the sieve 110. As indicated in FIG. 2, the sieve 110 has a dust collecting surface 110a and a back surface 110b opposite to the dust collecting surface 110a. The beating position can be a beating position A located in front of the sieve 110 and/or a beating position B located behind the sieve 110. The beating position A is located on a windward side close to the dust collecting surface 110a of the sieve 110 and the beating position B is located on a leeward side close to a back surface 110b of the sieve 110.

In an embodiment, the beater 112 beats the dust collecting surface 110a of the sieve 110 such that the dust comes off the sieve 110 due to the inertial effect and is then brought away by an air flow. In another embodiment, the beater 112 beats the back surface 110b of the sieve 110 such that the dust comes off the sieve 110 due to the vibration of the sieve 110 and then is brought away by an air flow. Or, the beater 112 beats the dust collecting surface 110a and the back surface 110b of the sieve 110, such that the dust comes off the sieve 110 due to the repeated vibration of the sieve 110 and then is brought away by an air flow. In the implementations disclosed above, a controller can be used to drive a fan 140 and change the direction of the air flow by controlling the direction of the fan 140.

Referring to an example in FIG. 2. When the fan 140 operates in a normal state, the fan 140 absorbs the air and guides an air flow A1 to enter the sieve 110, such that the dust D in the air is attached on a surface of the sieve 110. When the rotation of the fan 140 is reversed and changes the direction of the air flow A2, the air is discharged by the air flow A2 through the sieve 110. Meanwhile, the beater 112 beats the sieve 110, such that the dust D coming off the sieve 110 can be brought away by the air flow A2 whose direction is opposite to that of the air flow A1.

Besides, the dust cleaning apparatus 100 further comprises a first scroll 116 and a second scroll 118 for fixing and moving the sieve 110, such that the sieve 110 can be moveably extended to the second scroll 118 from the first scroll 116. Therefore, under the control of the two scrolls and the driver 114, the sieve 110 which is beaten by the beater 112 is moved at the same time, such that the beater 112 can keep beating the sieve 110 moving in a reciprocal motion to increase the beating effect.

In the embodiment disclosed above, the sieve 110 can be moved from the first scroll 116 to the second scroll 118 or from the second scroll 118 to the first scroll 116. The beater 112 can be located at a position relatively closer to the second scroll 118 or the first scroll 116. For instance, after the sieve 110 has been used for a predetermined period and needs to be cleaned, the beater 112 beats the sieve 110 at the position relatively closer to the second scroll 118, and the second scroll 118 drives the cleaned sieve 110 to pass through the beater 112 and move towards the second scroll 118 for a predetermined distance (the moving direction is indicated by an arrow B1) to retract to the second scroll 118. After the sieve 110 is completely cleaned, the first scroll 116 reversely drives the cleaned sieve 110 to move towards the first scroll 116 for a predetermined distance (the moving direction is indicated by an arrow B2) and retract to the first scroll 116. Meanwhile, the cleaned sieve 110 returns to its initial position and is capable of filtering the air again. Thus, the sieve 110 does not need to be detached and cleaned manually.

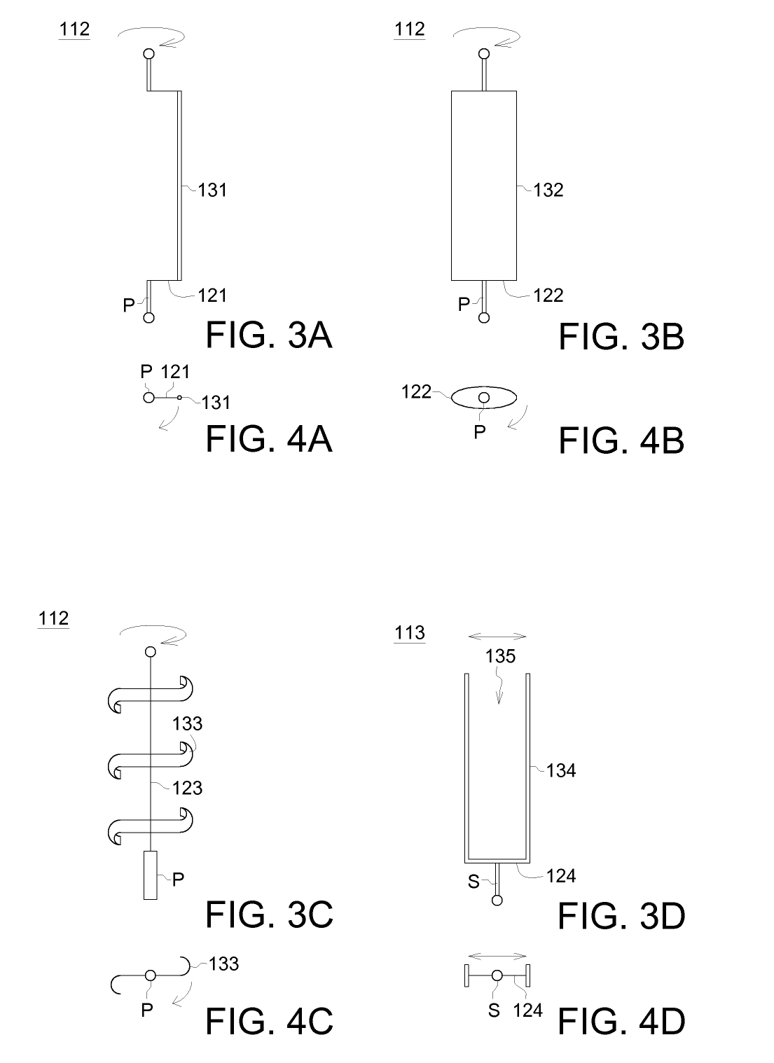

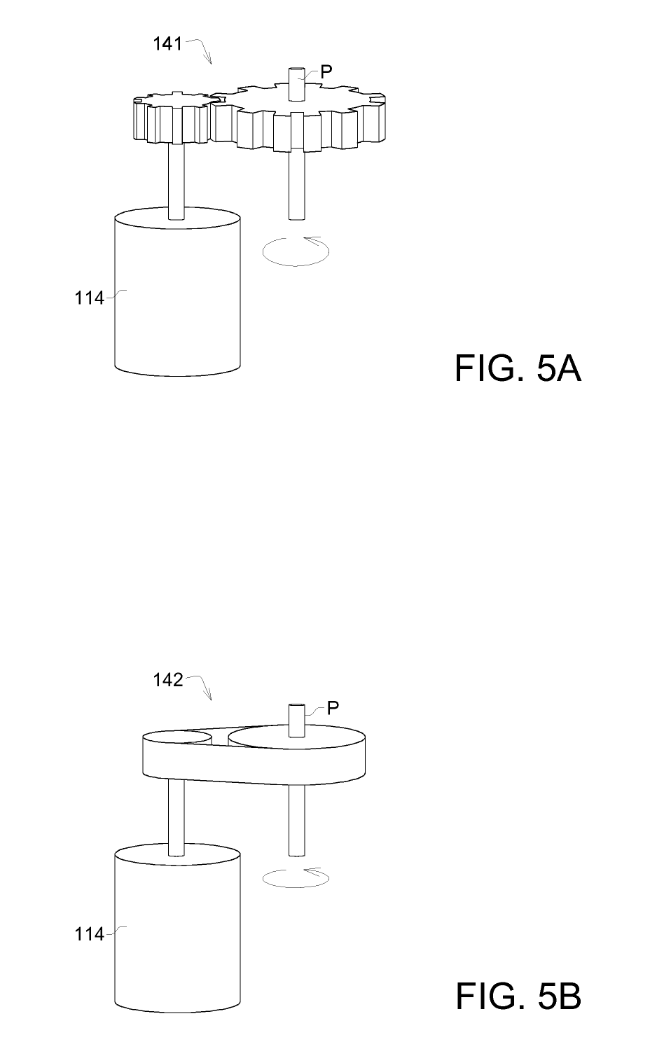

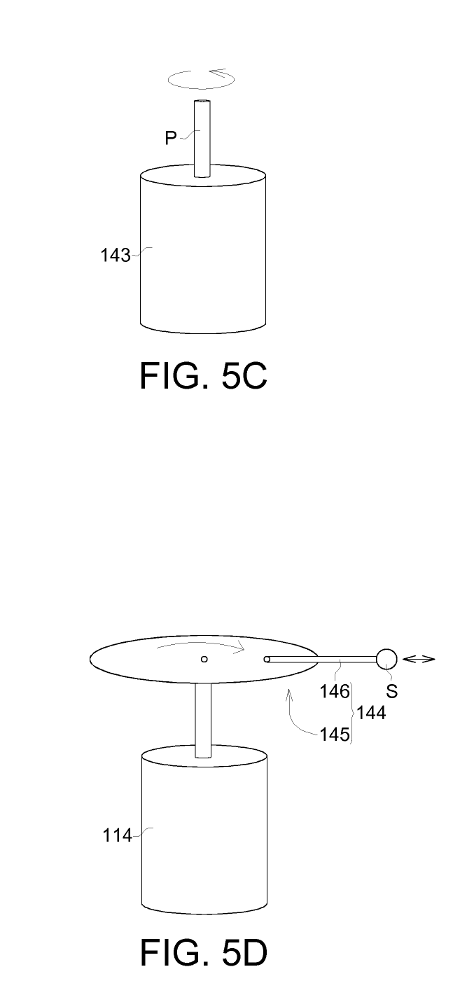

Descriptions of detailed structures of the beater 112 and the driver 114 are disclosed in following embodiments. FIGS. 3A˜3D are side views of four kinds of beaters 112. FIGS. 4A˜4D are top views of each kind of beater 112. FIGS. 5A˜5D are schematic diagrams of four kinds of drivers 114. The drivers 114 are not restricted to any particular types, such as a step motor or an electrical motor etc.

The beater 112 is not restricted to any particular types, such as a joystick type (FIG. 3A), a cylinder type (FIG. 3B), a rebound plate type (FIG. 3C) or a tuning fork type (FIG. 3D) etc. In FIG. 3A, the beater 112 comprises a moving part 121 and a rod 131. The moving part 121 rotates around a shaft P (FIG. 4A) for a circular movement. The rod 131, disposed on the moving part 121, beats the sieve 110 by the circular movement of the moving part 121 and is used as a beating part.

In FIG. 3B, the beater 112 comprises a moving part 122 and a cylinder 132. The moving part 122 rotates around a shaft P (FIG. 4B). The cylinder 132, disposed on the moving part 122, beats the sieve 110 by the circular movement of the moving part 122 and is used as a beating part.

In FIG. 3C, the beater 112 comprises a moving part 123 and a plurality of horizontally extended rebound plates 133. The moving part 123 rotates around a shaft P (FIG. 4C). The rebound plates 133, disposed on the moving part 123, beat the sieve 110 by the circular movement of the moving part 123 and are used as a beating part. It can be known from above disclosure that the beaters 112 in the disclosed embodiments can rotate around the shaft P to intermittently beat a surface of the sieve 110 through the rod 131, the cylinder 132, the rebound plates 133 or other type of beating part.

In FIG. 3D, the beater 113 comprises a moving part 124 and a fork 134. The moving part 124 vibrates relative to a supporting rod S (FIG. 4D). The fork 134, disposed on the moving part 124, beats the sieve 110 by the vibration of the moving part 124 and is used as a beating part. The fork 134 has a U-shaped recess 135, in which the sieve 110 can be placed. When the fork 134 vibrates with respect to the sieve 110, the fork 134 intermittently beats two opposite surfaces of the sieve 110 to clean the sieve 110.

In FIG. 5A, the driver 114 indirectly connects the shaft P by using a gear assembly 141 to drive one of the rotation type beaters 112 in FIGS. 3A-3C. In FIG. 5B, the driver 114 indirectly connects the shaft P by using a pulley assembly 142 to drive one of the rotation type beaters 112 in FIGS. 3A-3C. In FIG. 5C, the driver 114 directly connects the shaft P by using a direct drive motor 143 to drive one of the rotation type beaters 112 in FIGS. 3A-3C. The faster the rotation speed of the driver 114, the higher the beating frequency of the beater 112.

Besides, in comparison to the rotation type beaters 112 in FIGS. 3A-3C, the driver 114 outputs a power by way of vibration to drive the beater 113 in FIG. 3D. Please referring to FIG. 5D, the driver 114 indirectly connects the supporting rod S by using a crank shaft assembly 144, such that the supporting rod S vibrates reciprocally. Each time the crank shaft 145 rotates for one circle, the connecting rod 146 also drives the supporting rod S to vibrate reciprocally for one round, and the faster the rotation speed, the higher the vibrating frequency and the beating frequency.

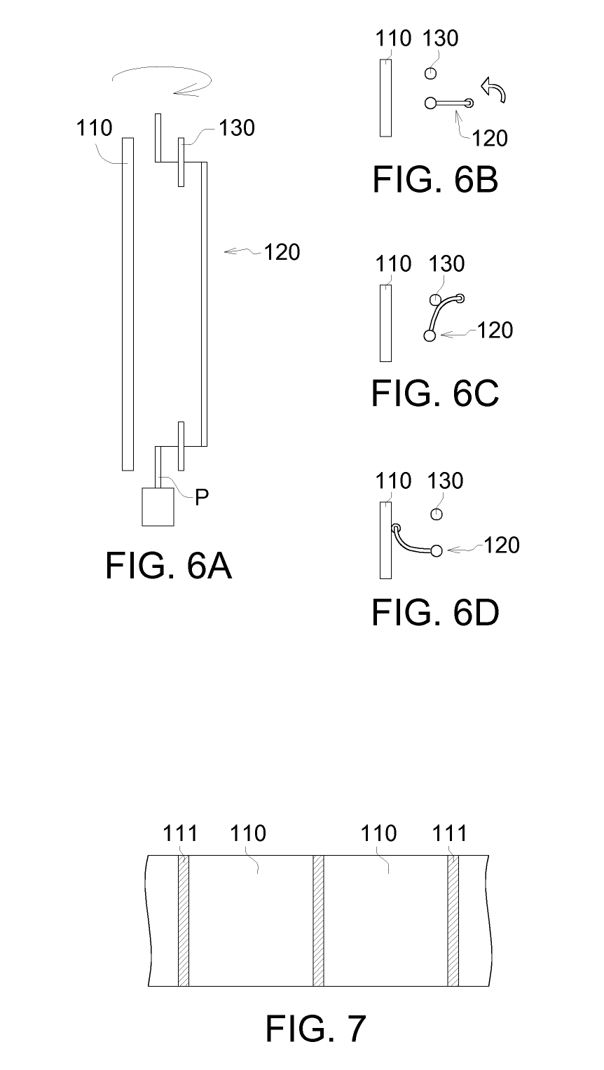

The beating energy can be increased by adjusting the rotation speed and the torque of the driver 114. Additionally, by adjusting the acceleration at the instant of beating, the beater 112 can release a larger amount of energy within a short period of beating time. Referring to FIG. 6A-6D, schematic diagrams of a beating part 120 storing and releasing kinetic energy by using a torque storage/release member 130 are shown. As indicated in FIG. 6B, the torque storage/release member 130 is disposed on top of the beating part 120 and/or bottom of the beating part 120 to flexibly contact the beating part 120. The torque storage/release member 130 can make flexible deformation of the beater 120 to store kinetic energy as indicated in FIG. 6C. When the stored kinetic energy is greater than a torque, the beating part 120 is released for beating the sieve 110 with the stored kinetic energy as indicated in FIG. 6D. Therefore, the beating part 120 can repeat the disclosed ways of releasing energy to increase the beating force. The beating part 120 can be any type of the beating parts in FIGS. 3A-3D.

Please referring to FIG. 7, in order to reinforce the strength of the sieve 110, a plurality of reinforcing ribs 111 are arranged at intervals disposed on a surface of the sieve 110 to receive the beating performed by the beating part. The reinforcing ribs 111 are not restricted to any particular forms or shapes, and can be a strip shape, a grid shape or a chessboard shape etc. Therefore, the reinforcing ribs 111 protect the sieve 110 when the beater beats the sieve 110, and also protect the sieve 110 from being pulled by an external force and being deformed when the sieve 110 is in motion.

The dust cleaning apparatus disclosed in the above embodiments cleans the dust by beating the sieve with a beater and produces a better dust cleaning effect than a brush or a scraper. Moreover, the beating type and the beating force of the beater can be adjusted by adjusting the kinetic energy of the rotation of the beater, adjusting the vibration amplitude of the beater or adding a torque storage/release member. The larger the beating force or the faster the acceleration at the instant of beating, the better the sieve cleaning effect.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A dust cleaning apparatus, comprising:
a sieve;
a beater for beating the sieve, wherein the beater comprises:
a moving part rotating around a shaft or vibrating relative to a supporting rod; and
a beating part disposed on the moving part for beating the sieve by the movement of the moving part; and
a driver connecting the shaft or the supporting rod to drive the moving part in motion.

2. The dust cleaning apparatus according to claim 1, wherein the beating part is a rod or a cylinder which rotates around the shaft to intermittently beat a surface of the sieve.

3. The dust cleaning apparatus according to claim 1, wherein the beating part comprises a plurality of rebound plates rotating around the shaft to intermittently beat a surface of the sieve.

4. The dust cleaning apparatus according to claim 1, wherein the driver indirectly connects the shaft through a gear assembly or a pulley assembly.

5. The dust cleaning apparatus according to claim 1, wherein the driver directly connects the shaft through a direct drive motor.

6. The dust cleaning apparatus according to claim 1, wherein the beating part is a fork, the sieve is placed in a U-shaped recess of the fork, and the fork vibrates with respect to the sieve to beat two opposite surfaces of the sieve intermittently.

7. The dust cleaning apparatus according to claim 1, wherein the driver indirectly connects the supporting rod through a crank shaft assembly.

8. The dust cleaning apparatus according to claim 1, further comprising a torque storage/release member for storing kinetic energy of the beating part and releasing the beating part to beat the sieve with the stored kinetic energy when the stored kinetic energy is greater than a torque.

9. The dust cleaning apparatus according to claim 1, wherein the sieve has a dust collecting surface and a back surface opposite to the dust collecting surface, and the beating part beats the sieve by contacting the dust collecting surface and/or the back surface.

10. The dust cleaning apparatus according to claim 1, wherein the sieve has a plurality of reinforcing ribs on a position where the beating part beats the sieve, the reinforcing ribs are arranged at intervals for receiving the beating performed by the beater.

11. The dust cleaning apparatus according to claim 1, further comprising a first scroll and a second scroll for fixing the sieve which is moveably extended to the second scroll from the first scroll, wherein after the sieve is used for a predetermined period, the sieve is driven to move towards the second scroll and retracts to the second scroll.

12. The dust cleaning apparatus according to claim 11, wherein the beater beats the sieve to clean the sieve at a position relatively closer to the second scroll.

13. The dust cleaning apparatus according to claim 11, wherein after the sieve is cleaned, the sieve is driven to move towards the first scroll and retracts to the first scroll.
